(19) United States
(12) Patent Application Publication
(10) Pub. No.: US 2004/0053616 A1
(43) Pub. Date: Mar. 18, 2004

(54) Method and apparatus for multiple terminal equipment routing

(76) Inventors: Eric John Overtoom, Grayslake, IL (US); Lawrence Alan Willis, McHenry, IL (US)

Correspondence Address: MOTOROLA INC, 600 NORTH US HIGHWAY 45, LIBERTYVILLE, IL, 60048-5343, US

(21) Appl. No.: 10/244,189

(22) Filed: Sep. 16, 2002

(51) Int. Cl. H04Q 7/20

(52) U.S. Cl. 455/445

(57) ABSTRACT

A method for routing data call events to at least one termination point coupled to a mobile communication device in communication with a mobile communication network. The method can include assigning criteria to the at least one termination point, receiving a data call event of a type of communication at the mobile communication device from the mobile communication network, determining a termination point recipient by comparing the type of communication with the criteria, and routing the communication to the termination point recipient. The method can also include assigning second criteria to a second termination point, receiving a data call event of a second type of communication at the mobile communication device from the mobile communication network, determining a second device recipient by comparing the second type of communication with the second criteria, and routing the second type of communication to the second device recipient.

### BACKGROUND OF THE INVENTION

1. Field of Invention

The present invention is directed to a method and apparatus for multiple terminal equipment routing. In particular, the present invention is directed to routing incoming data call events to terminal equipment coupled to a mobile communication device.

2. Description of Related Art

Presently, many mobile communication devices soon to be in production will offer the ability for termination elements such as multiple external devices to be attached to the mobile communication device. These external devices can include personal computers, personal digital assistants, or any other useful accessory device. These devices can use a mobile communication device as a wireless modem, to transmit and receive data from another system within a communication network. Additionally, the mobile communication device may have multiple internal applications that can also communicate with other devices in a communication network by using the mobile communication device as a kind of wireless modem.

In the traditional modem world, a modem is attached to a computer. When a call is received by the modem, the modem issues a “RING” notification to the computer. An application in the computer can then answer the incoming call, assuming the call is a data call. This system is acceptable because there is only one possible recipient of the incoming call.

The present inventors have recognized that a problem exists in a mobile communication environment because there are multiple possible recipients of a data call. Thus, it is difficult to determine which of the attached devices desires a particular incoming call. For example, an attached computer may only be interested in calls coming from a particular number. However, the attached computer may receive notifications of all calls from all numbers.

Other problems are created by sending incoming call notifications to all attached terminal elements. By sending incoming notifications to all terminal elements, two terminal elements may attempt to answer the call at the same time. The prevailing terminal element is the device that the mobile communication device receives a complete command from first, which may not always be the same device. Unfortunately, this may not be preferred device. Also, this leads to inconsistent operation for a user of the mobile communication device.

### SUMMARY OF THE INVENTION

The problem of determining an appropriate termination element recipient can be reduced by assuming that most of the attached termination elements are not interested in all of the incoming call information. For example, a facsimile application within a mobile communication device is not interested in an incoming packet-data call, since the data content is known to not be compatible. Among other benefits, the present invention can provide a method for applications and devices to request that certain calls or types of calls be correctly routed to them. The present invention can also provide the decisions involved in routing the incoming calls according to criteria that the devices request. Such criteria can include bearer type, such as circuit switched data, packet switched data, or the like; call type, such as data, facsimile, or the like for circuit switched calls; caller identification, such as calling line identification or the like for circuit switched calls; access point name or the like for packet switched calls; packet data protocol address or the like for packet switched calls; or any other useful criteria.

According to one embodiment, the present invention can provide a method for routing data call events to at least one termination point coupled to a mobile communication device in communication with a mobile communication network. This method can include assigning criteria to the at least one termination point, receiving a data call event of a type of communication at the mobile communication device from the mobile communication network, determining a termination point recipient by comparing the type of communication with the criteria, and routing the communication to the termination point recipient. The method can also include assigning second criteria to a second termination point, receiving a data call event of a second type of communication at the mobile communication device from the mobile communication network, determining a second device recipient by comparing the second type of communication with the second criteria, and routing the second type of communication to the second device recipient. The method can further include ascertaining the type of communication does not match the criteria, wherein the routing step can include routing the communication to another termination point based on ascertaining the type of communication does not match the criteria.

According to another embodiment, the present invention can provide a mobile communication device. The mobile communication device can include a first internal termination point, a second internal termination point, a call processing engine configured to generate a notification for an incoming data call event, and a data services module coupled to the call processing engine and coupled to the first internal termination point and the second internal termination point, wherein the data services module can be configured to receive the notification from the call processing engine and to determine an internal termination point recipient for receiving the incoming data call event based on criteria corresponding to the first internal termination point. The mobile communication device can also include registration database that can include a termination point entry corresponding to the first internal termination point and a criteria entry corresponding to the termination point entry. The first internal termination point can be coupled to external terminal equipment and the first internal termination point can forward the incoming data call event to the external terminal equipment. The internal termination point can be coupled to the external terminal equipment via a universal serial bus interface. The mobile communication device can additionally include a radio frequency interface coupled to the call processing engine and an antenna coupled to the radio frequency interface, wherein the radio frequency interface can provide a wireless connection to a mobile communication network. The first internal termination point can include a mobile communication device application.

According to another embodiment, the present invention can provide a method in a mobile communication device for routing data call events to a plurality of termination points coupled to the mobile communication device in communication with a mobile network. The method can include assigning criteria to the at least one termination point of the plurality of termination points, receiving a call event including a type of communication at the mobile communication device from the mobile network, comparing the type of communication to the criteria assigned to the at least one termination point of the plurality of termination points, determining a termination point recipient from the plurality of termination points based on comparing the type of communication to the criteria, and routing the communication to the termination point recipient if the type of communication matches the criteria.

According to another embodiment, the present invention can provide a method for routing call events to at least one termination point coupled to a mobile communication device. The method can include receiving a call event including a type of communication at the mobile communication device, matching the type of communication with a parameter requested by the termination point, and routing the communication to the termination point.

### BRIEF DESCRIPTION OF THE DRAWINGS

The preferred embodiments of the present invention will be described with reference to the following figures, wherein like numerals designate like elements, and wherein:

FIG. 1 is an exemplary block diagram of a mobile communication system according to one embodiment;

FIG. 2 is an exemplary block diagram of a mobile communication device according to one embodiment;

FIG. 3 is an exemplary block diagram of a data services module according to one embodiment; and

FIG. 4 is an exemplary flowchart outlining the operation of the data services module according to one embodiment;

### DETAILED DESCRIPTION OF PREFERRED EMBODIMENTS

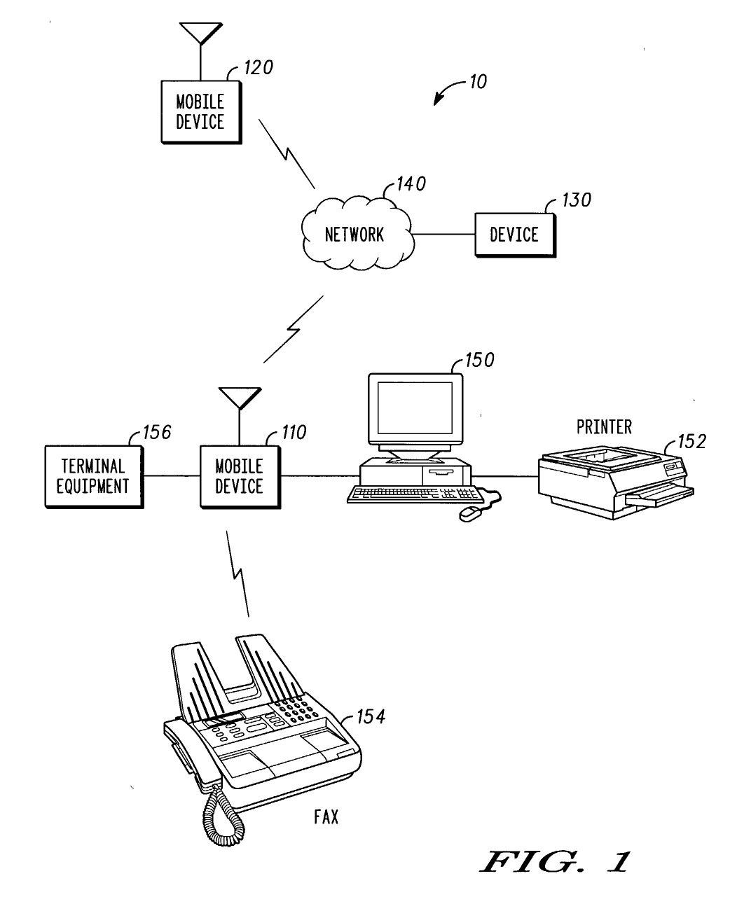

FIG. 1 is an exemplary block diagram of a mobile communication system 10 according to one embodiment of the invention. The system 10 can include mobile communication devices 110 and 120, additional communication devices such as device 130, and a network 140. The mobile communication device 110 may communicate with terminal equipment such as a personal computer 150, a printer 152, a facsimile machine 154, or another terminal equipment 156. For example, the mobile communication device 110 may be coupled to a personal computer 150 or other terminal equipment via a Universal Serial Bus (USB) connection, a serial port connection, an infrared connection, a Bluetooth connection, or any other connection useful for communicating between two devices. The personal computer 150 may also be coupled to a printer 152 via a communication connection such as a USB connection. The mobile communication device may then communicate with the printer 152 via the personal computer 150. The mobile device 110 may include a wireless telephone, a cellular telephone, a PDA, a pager, or any other device that is capable of sending and receiving data.

The network 140 may include any type of network that is capable of sending and receiving communication signals. Preferably, the network 140 is a wireless communication network. Also, the network 140 may include or be in communication with a data network, such as the Internet, an Intranet, a local area network (LAN), a wide area network (WAN), a cable network, and other like communication systems. The network 140 may also include or be in communication with a telecommunications network, such as a local telephone network, long distance telephone network, cellular telephone network, satellite communications network, cable television network and other like communications systems. Furthermore, the network 140 may include or be in communication with more than one network and may include a plurality of different types of networks. Thus, the network 140 may include or be in communication with a plurality of data networks, a plurality of telecommunications networks, a combination of data and telecommunications networks and other like communication systems.

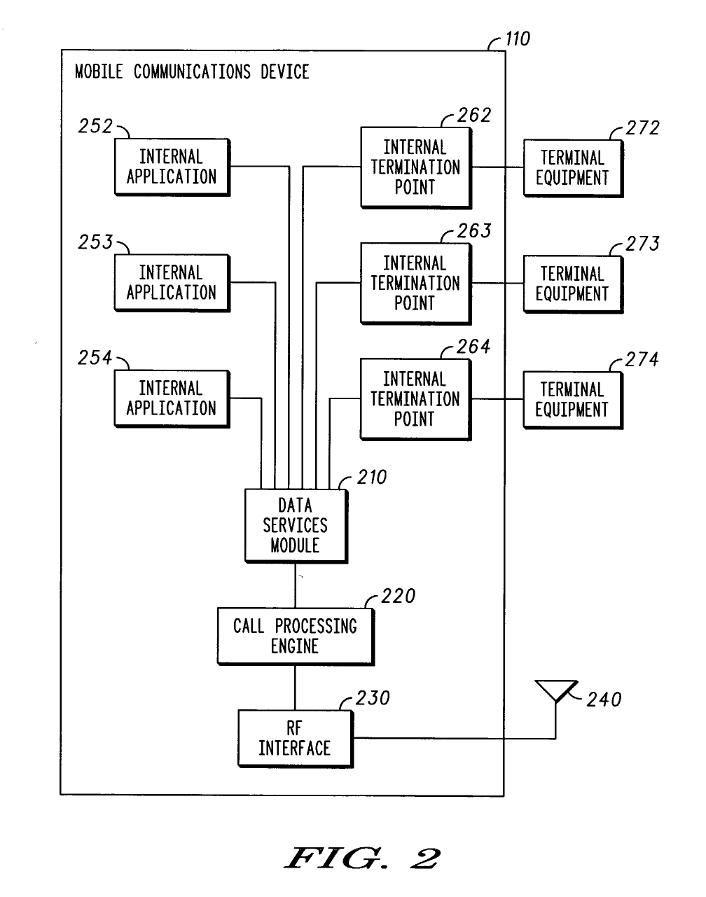

FIG. 2 is an exemplary block diagram of a mobile communication device 110 according to one embodiment. The mobile communication device 110 can include a data services module 210, a call processing engine 220 coupled to the data services module 210, a radio frequency (RF) interface 230 coupled to the call processing engine 220, and an antenna 240 coupled to the RF interface 230. The RF interface 230 can provide a wireless connection to data service and voice communications. The mobile communication device 110 can also include termination elements 252-254, 262-264, and 272-274. For example, the mobile communication device 110 can include internal termination points 252-254 and 262-264. The internal termination points 252-254 may be internal applications in the mobile communication device 110. For example, the internal communication point 252 may be a web browser, text messaging software, a caller identification utility, a software update module, or any other application useful in a mobile communication device. For a further example, the software update module may interact with an external server for updating software within the mobile communication device 110. The internal termination points 262-264 may be internal interfaces for connection to external terminal equipment 272-274. For example, the internal termination point 262 may be a universal serial bus (USB) interface, a Bluetooth interface, a RS-232 interface, an infrared interface, or any other interface useful for communicating between devices.

The external terminal equipment 272-274 may be any device useful in communication with a mobile communication device. For example, the external equipment 272 may be a facsimile device, a personal computer, a printer, a caller identification terminal, or any other device useful for communicating with a mobile communication device. Each termination element 252-254, 262-264, and 272-274 can communicate with the data services module 210 and can use the mobile communication device 110, for example, as a wireless modem for transmitting and receiving data.

In operation, the mobile communication device 110 may include an initialization sequence for the termination elements 252-254, 262-264, and 272-274. For example, the initialization sequence may be implemented when an application 252 starts up or when an external device 272 is attached to the mobile communication device 110. A termination element 252-254, 262-264, and 272-274 can request that particular incoming call is routed to it. For example, an internal application 252-254 may request a particular incoming call via a function call to the data services module 210 when it first establishes a connection. As another example, a terminal equipment device 272 may request a particular incoming cal via the use of an AT (attention) command to configure an interest list. The data services module 210 can maintain the interest list of which termination elements are interested in which incoming services or callers to the mobile communication device 110.

For example, a facsimile application may be interested in any incoming circuit switched calls of a facsimile type, a browser application may be interested in any incoming packet-switch calls from the address of a WAP gateway, and another application may be interested in any incoming packet-switch calls from the address of a server in a carrier network. Also, a Bluetooth connected personal computer may not be interested in any incoming calls and a USB connected personal computer may be willing to accept anything. Each termination element may start with a default of being notified of any incoming calls and may have the option of requesting that the set of incoming calls be restricted in some way, such as by address or call type.

Then, when an incoming data call is received, the data services module 210 may evaluate the call information against criteria such as a list of attached devices and their interests. For example, the data services module 210 may evaluate the type, the service, and the originator identification of an incoming call. If a match is found, the data services module 210 can pick the most restrictive match and notify only that termination element of the incoming call. Other termination elements may not receive notification. For example, by choosing the most restrictive match, most ties can be resolved. In particular, if one termination element asks for calls from 888-555-1212 and one asks for facsimile calls, when a facsimile call is received from 888-555-1212, the data services module 210 can route the call to the termination element that asked for the phone number rather than the termination element that asked for the facsimile calls. The selected termination element can then respond to the call notification as appropriate to answer the call.

In the event that no termination elements have shown an interest in the call, the data services module 210 can present a notification to all termination elements that are still in a default configuration with no restrictions. If there are no termination elements that are unrestricted, the data services module 210 can cause a message to be presented to a user, asking that an appropriate device be attached. Alternatively, the data services module 210 can reject the incoming call.

More than one termination element may match the request restrictions for an incoming call. For example, two termination elements may have no restrictions in place. The data service module 210 can then present the notification sequentially to each registered termination element, preferably in registration order. The data services module 210 can then route the call to the termination element that answers first.

The mobile communication device 110 may maintain multiple calls at one time. In the event that a new call is received that matches the request for a termination element that is already in a call, the data services module 210 may perform one of at least three functions. First, the data services module 210 can return a busy call indication to the caller. Second, the data services module 210 can continue evaluating the call and if another matching termination element is found, it can present the call to that match. Third, the data services module 210 can present the call to a termination element that has not registered for specific call notifications.

According to a preferred embodiment, the data services module 210 can receive all in coming call notifications and can communicate these to the termination elements. For example, the data services module 210 may include a calling application. The calling application can receive the call notifications and the related data. The data services module 210 can also include a data application used to communicate with the outside world. These applications may reside in the controller described below. An algorithm for call routing and termination element selection may reside within the calling application, which can advertise an incoming call to a single termination element. This offers significant call routing efficiency advantages over a broadcast notification technique. The incoming call notifications can be received from the RF interface 230 via the call processing engine 220. Alternatively, the functions of the call processing engine 220 and the RF interface 230 may be combined with each other or with the data services module 210.

As discussed above, the internal termination points 252-254 and 262-264 can include applications such as internal applications 252-254 and internal interfaces 262-264. The internal applications 252-254 can include facsimile receivers, web browsers, and other applications that are able to use data services. The internal interfaces 262-264 can provide command interfaces to external terminal equipment and devices. The internal termination points 252-254 and 262-264 can make requests of the data services module 210 to configure particular incoming calls to be received by the data services module 210. For example, an external terminal equipment device 272 can issue a command, such as an AT command, to the internal interface 262. The internal interface 262 can then issue a request to the data services module 210. As another example, an internal application 252 can also issue a request to the data services module 210. The relevant internal termination point can then be responsible for handling an incoming call notification appropriately. For example, an internal application 252 can accept a notification and answer a related call. Also, an internal interface 262 can generate a response, such as a “ring” response, and then either answer the call or wait for an external terminal equipment device 272 to answer the call.

The external terminal equipment 272-274 may attach to the mobile communication device 110 to use it as a wireless modem. While such connections can often be outgoing, some connections can support incoming calls. An external terminal equipment device can have the option of configuring an auto-answer mode. For example, in such a mode, the mobile communication device 110 can automatically answer a call after a certain number of rings. If auto-answer is not configured, the external terminal equipment device can issue an appropriate command to answer a call when one is received.

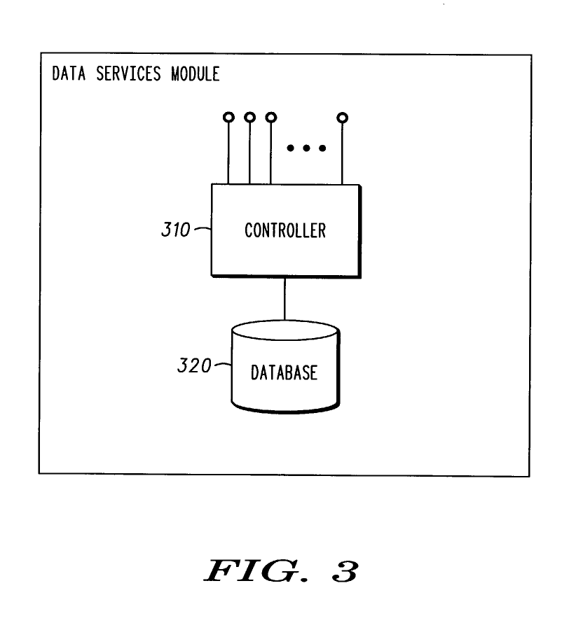

FIG. 3 is an exemplary block diagram of a data services module 210 according to one embodiment. The data services module 210 can include a controller 310 and a database 320. The controller can control the operations of the data services module 210. The controller 310 can also be located outside of the data services module 210 and can control the operations of the entire mobile communications device 210. The database 320 can include entries for the termination elements 252-254, 262-264, and 272-274 that have registered for specific notifications. The database 320 can store a pointer to a termination element, to a call type, if any, the termination element is registered for, the originator identification the termination element has registered for, and any other useful information, criteria, parameters, or the like. The database 320 can be indexed by the order in which the termination elements register with the data services module 210. According to another embodiment, multiple databases may be used. One database may be used for originator identifications and one for call types, indexed by the originator identification or the call type, with each record containing a pointer to the relevant termination element. The multiple databases can then be searched quickly to determine if there is a registration for a particular incoming call.

For an external terminal equipment device, registration may be performed by using AT commands. The command can be parsed by a command application, such as an internal termination interface 262-264, which then provides the registration data to the data services module 210. The data services module 210 can then store a pointer to the internal termination interface, which can then communicate with the specific terminal equipment device.

According to similar embodiment, the call processing engine 220 can generate the notifications for incoming calls. These notifications can be sent to the data services module 210. The data services module 210 can then determine, based on the registration database 320, which termination element to pass the incoming call notification to.

According to a similar embodiment, the mobile communication device 110 can include a first internal termination point such as termination elements 252-254 or 262-264 a second internal termination point such as termination elements 252-254 or 262-264, a call processing engine 220 configured to generate a notification for an incoming data call event, and a data services module 210 coupled to the call processing engine and coupled to the first internal termination point and the second internal termination point. The data services module 210 can be configured to receive the notification from the call processing engine 220 and to determine an internal termination point recipient for receiving the incoming data call event based on criteria corresponding to the first internal termination point.

The mobile communication device 110 can also include a registration database 320 that can include a termination point entry corresponding to the first internal termination point and a criteria entry corresponding to the termination point entry. The first internal termination point can be coupled to external terminal equipment such as terminal equipment 272-274 and the first internal termination point can forward the incoming data call event to the external terminal equipment. The first internal termination point can be coupled to the external terminal equipment via a universal serial bus interface, a Bluetooth interface, a serial port interface, or any other interface useful for communicating between two devices.

The mobile communication device 110 can also include a radio frequency interface 230 coupled to the call processing engine 220 and an antenna 240 coupled to the radio frequency interface 230 and the radio frequency interface 230 can provide a wireless connection to a mobile communication network. The first internal termination point can be a mobile communication device application such as a wireless web browser, a messaging application, an e-mail application, or any other application useful in a mobile communication device.

The data call event can include a type of communication. The data services module 210 can include the registration database 320. Also, the registration database 320 can include criteria assigned to the first internal termination point and the data services module 210 can be further configured to determine the internal termination point recipient based on comparing the criteria to the type of communication.

The data services module 210 can be further configured to determine two different possible internal termination point recipients based on similar criteria assigned to the two possible internal termination point recipients and the data services module 210 can also be configured to determine the internal termination point recipient for receiving the incoming data call event based on the internal termination point recipient having priority over another possible termination point recipient. The data services module 210 can additionally be configured to determine the termination point recipient is already engaged in a communication and to provide a busy signal to an originator of the data call event. The criteria can be at least one of an access point name and a packet data protocol address.

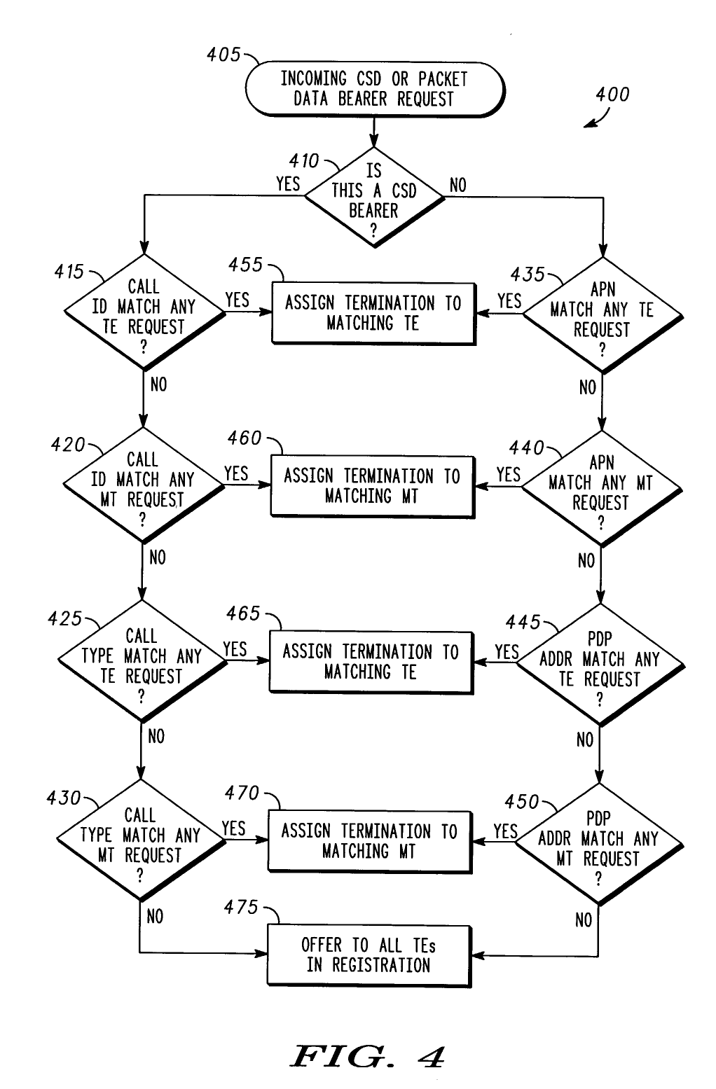

FIG. 4 is an exemplary flowchart outlining the operation of the data services module 210 according to one embodiment. In step 405, the data services module 210 receives an incoming circuit switched data (CSD) or packet data bearer request. In step 410, the data services module 210 determines if the request is a CSD request. If so, in step 415, the data services module 210 determines if a caller identification matches a terminal equipment request. If not, in step 420, the data services module 210 determines if the caller identification matches an internal application request. If not, in step 425, the data services module 210 determines if the call type matches any terminal equipment request. If not, in step 430, the data services module 210 determines if the call type matches any internal application request. If not, in step 475, the data services module 210 offers the call to all termination elements in registration order.

In step 410, if the data services module 210 determines the request is not a CSD request, in step 435, the data services module 210 determines if an access point name matches a terminal equipment request. If not, in step 440, the data services module 210 determines if the access point name matches an internal application request. If not, in step 445, the data services module 210 determines if a packet data protocol address matches any terminal equipment request. If not, in step 450, the data services module 210 determines if the packet data protocol address matches any internal application request. If not, in step 475, the data services module 210 offers the call to all termination elements in registration order.

If in step 415 the data services module 210 determines a caller identification matches a terminal equipment request or in step 435 the data services module 210 determines an access point name matches a terminal equipment request, in step 455 the data services module 210 can assign termination of the call to a matching terminal equipment device. If in step 420 the data services module 210 determines the caller identification matches an internal application request or in step 440 the data services module 210 determines the access point name matches an internal application request, in step 460 the data services module 210 can assign termination of the call to a matching internal termination point. If in step 425 the data services module 210 determines the call type matches any terminal equipment request or in step 445 the data services module 210 determines a packet data protocol address matches any terminal equipment request, in step 465 the data services module 210 can assign termination of the call to a matching terminal equipment device. If in step 430 the data services module 210 determines the call type matches any internal application request or in step 450 the data services module 210 determines the packet data protocol address matches any internal application request, in step 470 the data services module 210 can assign termination of the call to a matching internal termination point.

According to another related embodiment, the data services module 210 or the controller 310 can assign criteria to one termination point, such as a termination element 252-254, 262-264, or 272-274. The mobile communication device 110 can receive a data call event of a type of communication from a mobile communication network, such as network 140. The data services module 210 can then determine a correct termination point recipient by comparing the type of communication with the criteria. The data services module 210 can then route the communication to the termination point recipient.

Also, the data services module 210 can assign a second criteria to a second termination point, receive a data call event of a second type of communication at the mobile communication device 110 from the network 140, determine a second device recipient by comparing the second type of communication with the second criteria, and route the second type of communication to the second device recipient. Additionally, the data services module 210 can ascertain the type of communication does not match the criteria and route the communication to another termination point based on ascertaining the type of communication does not match the criteria.

Furthermore, data services module 210 can ascertain two different possible termination point recipients based on the type of communication and based on same criteria assigned to the two possible termination point recipients and select one termination point to be the termination point recipient based on the one termination point being the first termination point registered with the criteria assigned to the two possible termination point recipients. The data services module 210 can also receive a requested parameter from the termination point, the requested parameter corresponding to a type of communication and store criteria for the termination point corresponding to the requested parameter. The data services module 210 can additionally receive a criteria request from the at least one termination point and receive a criteria request from a second termination point these requests can then be used as assigned criteria for the termination points.

The data services module 210 can further ascertain the criteria request received from the second termination point is substantially related to the criteria request received from the at least one termination point and deny the criteria request from the second termination point. The data services module 210 can also receive a type of communication indicator on an out of band management channel and determine a termination point recipient based on the type of communication indicator and the criteria.

The data services module 210 can additionally ascertain there are no termination points coupled to the mobile communication device utilize the type of communication received and request a user of the mobile communication device to attach an appropriate device. The data services module 210 can also ascertain no termination points coupled to the mobile communication device utilize the type of communication and reject the communication. The data services module 210 can further ascertain the termination point recipient is already engaged in a communication and provide a busy signal to an originator of the data call event. The data services module 210 can additionally ascertain the termination point recipient is already engaged in a communication, determine a second termination point recipient based on the type of communication, and route the communication to the second termination point recipient. The type of communication can be a bearer type of communication and the bearer type of communication can be a circuit switched communication type or a packet switched communication type. The type of communication can also be a call type of communication and the call type of communication can be a data communication type or a facsimile communication type. The type of communication can additionally be a caller identification communication type, the caller identification communication type including a first caller identification type and a second caller identification type. The criteria can be a caller identity, an access point name, or a packet data protocol address.

According to another embodiment, the data services module 210 can assign criteria to the at least one termination point of the plurality of termination points 252-254, 262-264, and 272-274, receive a call event including a type of communication at the mobile communication device 110 from the mobile network such as the network 140, compare the type of communication to the criteria assigned to the at least one termination point of the plurality of termination points 252-254, 262-264, and 272-274, determine a termination point recipient from the plurality of termination points 252-254, 262-264, and 272-274 based on comparing the type of communication to the criteria, and route the communication to the termination point recipient if the type of communication matches the criteria.

According to another related embodiment, the data services module 210 can receive a call event including a type of communication at the mobile communication device 110, match the type of communication with a parameter requested by the termination point, and route the communication to the termination point. The type of communication may be a caller identity. The data services module 210 may also receive a requested parameter from the termination point, the requested parameter corresponding to a type of communication.

The method of this invention is preferably implemented on a programmed processor. However, data services module 210 and/or the controller 310 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

What is claimed is:

1. A method for routing data call events to at least one termination point coupled to a mobile communication device in communication with a mobile communication network, comprising:
assigning criteria to the at least one termination point;
receiving a data call event of a type of communication at the mobile communication device from the mobile communication network;
determining a termination point recipient by comparing the type of communication with the criteria; and
routing the communication to the termination point recipient.

2. The method according to claim 1, further comprising:
assigning second criteria to a second termination point;
receiving a data call event of a second type of communication at the mobile communication device from the mobile communication network;
determining a second device recipient by comparing the second type of communication with the second criteria; and
routing the second type of communication to the second device recipient.

3. The method according to claim 1, further comprising:
ascertaining the type of communication does not match the criteria,
wherein the routing step comprises routing the communication to another termination point based on ascertaining the type of communication does not match the criteria.

4. The method according to claim 1, further comprising:
ascertaining two different possible termination point recipients based on the type of communication and based on same criteria assigned to the two possible termination point recipients; and
selecting one termination point to be the termination point recipient based on the one termination point being the first termination point registered with the criteria assigned to the two possible termination point recipients.

5. The method according to claim 1, further comprising
receiving a requested parameter from the termination point, the requested parameter corresponding to a type of communication; and
storing criteria for the termination point corresponding to the requested parameter.

6. The method according to claim 1, further comprising:
receiving a criteria request from the at least one termination point; and
receiving a criteria request from a second termination point.

7. The method according to claim 6, further comprising:
ascertaining the criteria request received from the second termination point is substantially related to the criteria request received from the at least one termination point; and
denying the criteria request from the second termination point.

8. The method according to claim 1, further comprising receiving a type of communication indicator on an out of band management channel,
wherein the determining step further comprises determining a termination point recipient based on the type of communication indicator and the criteria.

9. The method according to claim 1, further comprising:
ascertaining no termination points coupled to the mobile communication device utilize the type of communication; and
requesting a user of the mobile communication device to attach an appropriate device.

10. The method according to claim 1, further comprising:
ascertaining no termination points coupled to the mobile communication device utilize the type of communication; and
rejecting the communication.

11. The method according to claim 1, further comprising:
ascertaining the termination point recipient is already engaged in a communication; and
providing a busy signal to an originator of the data call event.

12. The method according to claim 1, further comprising:
ascertaining the termination point recipient is already engaged in a communication; and
determining a second termination point recipient based on the type of communication,
wherein the routing step comprises routing the communication to the second termination point recipient.

13. The method according to claim 1, wherein the type of communication comprises a bearer type of communication, the bearer type of communication including at least one of a circuit switched communication type and a packet switched communication type.

14. The method according to claim 1, wherein the type of communication comprises a call type of communication, the call type of communication including at least one of a data communication type and a facsimile communication type.

15. The method according to claim 1, wherein the type of communication comprises a caller identification communication type, the caller identification communication type including a first caller identification type and a second caller identification type.

16. The method according to claim 1, wherein the criteria comprises a caller identity.

17. The method according to claim 1, wherein the criteria comprises an access point name.

18. The method according to claim 1, wherein the criteria comprises a packet data protocol address.

19. A mobile communication device, comprising:
a first internal termination point;
a second internal termination point;
a call processing engine configured to generate a notification for an incoming data call event; and
a data services module coupled to the call processing engine and coupled to the first internal termination point and the second internal termination point,
wherein the data services module is configured to receive the notification from the call processing engine and to determine an internal termination point recipient for receiving the incoming data call event based on criteria corresponding to the first internal termination point.

20. The mobile communication device according to claim 19, further comprising a registration database,
wherein the registration database includes
a termination point entry corresponding to the first internal termination point, and
a criteria entry corresponding to the termination point entry.

21. The mobile communication device according to claim 19, wherein the first internal termination point is coupled to external terminal equipment,
wherein the first internal termination point forwards the incoming data call event to the external terminal equipment.

22. The mobile communication device according to claim 21, wherein the first internal termination point is coupled to the external terminal equipment via a universal serial bus interface.

23. The mobile communication device according to claim 19, further comprising:
a radio frequency interface coupled to the call processing engine; and
an antenna coupled to the radio frequency interface,
wherein the radio frequency interface provides a wireless connection to a mobile communication network.

24. The mobile communication device according to claim 19, wherein the first internal termination point comprises a mobile communication device application.

25. The mobile communication device according to claim 19,
wherein the data call event includes a type of communication,
wherein the data services module includes a registration database,
wherein the registration database includes criteria assigned to the first internal termination point, and
wherein the data services module is further configured to determine the internal termination point recipient based on comparing the criteria to the type of communication.

26. The mobile communication device according to claim 25,
wherein the data services module is further configured to determine two different possible internal termination point recipients based on similar criteria assigned to the two possible internal termination point recipients, and
wherein the data services module is further configured to determine the internal termination point recipient for receiving the incoming data call event based on the internal termination point recipient having priority over another possible termination point recipient.

27. The mobile communication device according to claim 25, wherein the data services module is further configured to determine the termination point recipient is already engaged in a communication and to provide a busy signal to an originator of the data call event.

28. The mobile communication device according to claim 25, wherein the criteria comprises at least one of an access point name and a packet data protocol address.

29. A method in a mobile communication device for routing data call events to a plurality of termination points coupled to the mobile communication device in communication with a mobile network, comprising:
assigning criteria to the at least one termination point of the plurality of termination points;
receiving a call event including a type of communication at the mobile communication device from the mobile network;
comparing the type of communication to the criteria assigned to the at least one termination point of the plurality of termination points;
determining a termination point recipient from the plurality of termination points based on comparing the type of communication to the criteria; and
routing the communication to the termination point recipient if the type of communication matches the criteria.

30. A method for routing call events to at least one termination point coupled to a mobile communication device, comprising:
receiving a call event including a type of communication at the mobile communication device;
matching the type of communication with a parameter requested by the termination point; and
routing the communication to the termination point.

31. The method according to claim 30, wherein the type of communication comprises a caller identity.

32. The method according to claim 30, further comprising receiving a requested parameter from the termination point, the requested parameter corresponding to a type of communication.
